(19) United States
(12) Patent Application Publication
(10) Pub. No.: US 2024/0029135 A1
(43) Pub. Date: Jan. 25, 2024

(54) PERSONALIZED ITEM RECOMMENDATIONS USING A HYPER-CONVOLUTIONAL MODEL

(71) Applicant: Microsoft Technology Licensing, LLC, Redmond, WA (US)

(72) Inventors: Ori KATZ, Tel Aviv (IL); Oren BARKAN, Tel Aviv (IL); Nir NICE, Tel Aviv (IL); Noam KOENIGSTEIN, Tel Aviv (IL)

(21) Appl. No.: 17/814,504

(22) Filed: Jul. 22, 2022

(51) Int. Cl. G06Q 30/06; G06N 3/04

(52) U.S. Cl. CPC G06Q 30/0631; G06N 3/0454; G06N 3/0481

(57) ABSTRACT

The disclosure herein describes providing item selection recommendations using prediction scores based on a user's selection cycle of an item. A set of filter weights is generated using a trained hypernetwork. The set of filter weights is specific to a user and an item. Each filter weight is indicative of a probability that the user will select the item at the associated time period. A prediction score is generated for the item using the set of filter weights and item selection history data of the user, including a time period at which the user last selected the item. A selection recommendation is then provided to the user based at least in part on the generated prediction score during a current time period. The disclosure uses filter weights associated with explicit time periods to capture selection cycles of items for the user to improve the accuracy of provided selection recommendations.

### BACKGROUND

The Next Basket Recommendation (NBR) problem and the Next Basket Repurchase Recommendation (NBRR) problem are active related research fields that deal with recommending items for users' item selections during an item selection session based on sequences of their prior selections. Previous solutions for these problems analyze ordered sequences of historical sets of selected items to generate recommendations.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for providing item selection recommendations using prediction scores based on a user's selection cycle of an item is described. A set of filter weights is generated using a trained hypernetwork. The set of filter weights is specific to a user profile and an item (a user-item pair). Each filter weight of the set is indicative of a probability that the user profile will select the item at the associated time period. A prediction score is generated for the item using the set of filter weights and item selection history data of the user profile, including a time period at which the user profile last selected the item. A selection recommendation is then provided to a user interface associated with the user profile based at least in part on the generated prediction score during a current time period. Further, in some examples, the prediction score is based on item correlation data indicative of selection correlations between items for the user profile.

### BRIEF DESCRIPTION OF THE DRAWINGS

The present description will be better understood from the following detailed description read in light of the accompanying drawings, wherein:

FIG. 1 is a block diagram illustrating a system configured for generating combined prediction scores associated with item selection history data;

FIG. 2 is a block diagram illustrating a system configured for using a selection cycle network to generate selection cycle prediction scores;

FIG. 3 is a block diagram illustrating a system configured for using an item correlation network to generate an item correlation matrix;

FIG. 4 is a flowchart illustrating a method for generating a prediction score for an item based on a user-specific selection cycle;

FIG. 5 is a flowchart illustrating a method for generating a prediction score based on a user-specific selection cycle and item correlation data;

FIG. 6 is a flowchart illustrating a method for generating a set of filter weights using a trained hypernetwork;

FIG. 7 is a flowchart illustrating a method for generating an item correlation matrix;

FIG. 8 is a flowchart illustrating a method for providing a recommendation to a user based on combined prediction scores of items in the user's history data; and

FIG. 9 illustrates an example computing apparatus as a functional block diagram.

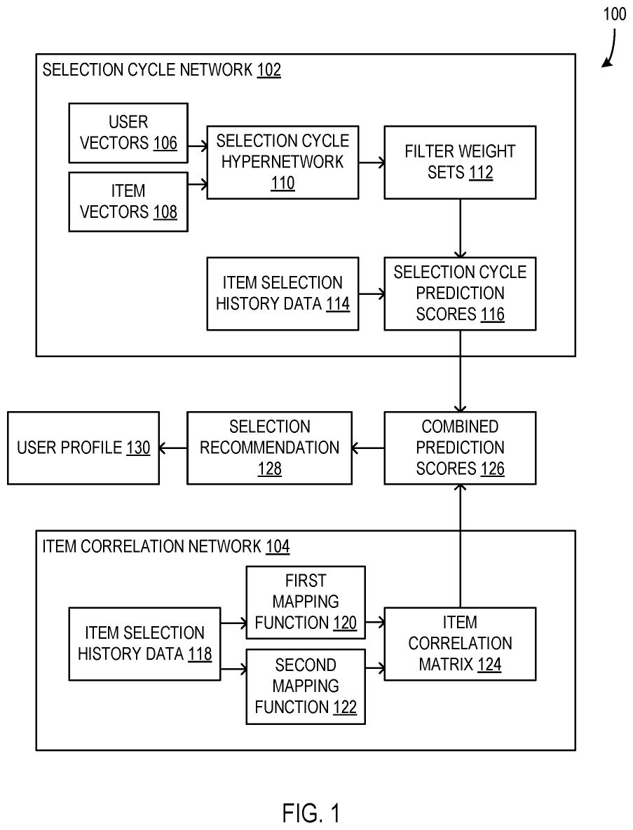

Corresponding reference characters indicate corresponding parts throughout the drawings. In FIGS. 1 to 9, the systems are illustrated as schematic drawings. The drawings may not be to scale.

### DETAILED DESCRIPTION

Aspects of the disclosure provide a computerized method and system for generating prediction scores and providing recommendations for item selection during an item selection session. The disclosure describes generating sets of filter weights for specific user-item pairs that are representative of the user's item selection cycle for that item over time. The sets of filter weights are used with the user's selection history data to generate item selection cycle prediction scores for the user. Those scores can be used to make recommendations to the user, or they can be combined with other predictive data to provide improved recommendations. For instance, the disclosure describes generating an item correlation matrix from the user's selection history data to represent the likelihood that the user will select a pair of items together. The item correlation matrix can be combined with the item selection cycle prediction scores as described herein to generate combined prediction scores that accurately predict user selection behavior.

The disclosure operates in an unconventional manner at least by using hypernetwork architecture and explicit timestamps of past selection data to train a model to predict next basket selections (where a basket is a group or set of items that are selected at substantially the same time or otherwise selected together during a selection session) based on a specific user's selection cycle (or buy cycle in examples where items are being bought) for individual items. Further, the disclosure combines this selection cycle modeling with an item correlation model that generates item correlations values in a matrix. By combining both the selection cycle model and the item correlation model, the disclosure performs efficient, accurate predictions of next basket selections that are individualized to specific users, enabling the providing of personalized recommendations to those users. Further, by using explicit timestamps, the disclosure enables the trained models to account for selection cycle patterns of users that are difficult or impossible to detect using implicit timestamps, as are used by many other prior art solutions.

Additionally, the disclosure specifically describes the use of hypernetwork architecture for modeling selection cycle behavior of specific users. The use of the hypernetwork to generate filter weights for use by the second network in generating item reselection predictions is an efficient alternative to other possible implementations in resource use and time use contexts. Further, the use the hypernetwork architecture enables the explicit timestamps to be used more efficiently and effectively than other possible implementations, thus overcoming challenges associated with methods used by prior art solutions (e.g., the use of explicit timestamps with recurring neural networks is more challenging).

The NBRR problem may initially appear as an easy task. However, different users exhibit different selection cycles for different items. For example, a user who is single probably has a longer selection cycle for toilet paper than a parent who buys for the entire family. However, both have shorter selection cycles for bananas due to their short expiry date. In the former case, the selection cycle is determined by the consumption rate of different users, whereas in the latter example, it is determined by the item's durability. Unfortunately, both users' metadata as well as items' durability are often unknown to the recommender system, and in any case, they are not the sole factors that determine reselection cycles. Hence, the main difficulty in NBRR stems from the need to estimate different reselection cycles for every combination of user and item based on historical selections only. The disclosure addresses these differences by analyzing selection cycles at the user and item level and doing so in the context of explicit timestamps, such that differing selection cycles become apparent.

FIG. 1 is a block diagram illustrating a system 100 configured for generating combined prediction scores 126 associated with item selection history data 114. In some examples, the system 100 includes a selection cycle network 102 configured to generate selection cycle prediction scores 116 and an item correlation network 104 configured to generate an item correlation matrix 124. The selection cycle prediction scores 116 are combined with the item correlation matrix 124 to generate the combined prediction scores 126 as described herein.

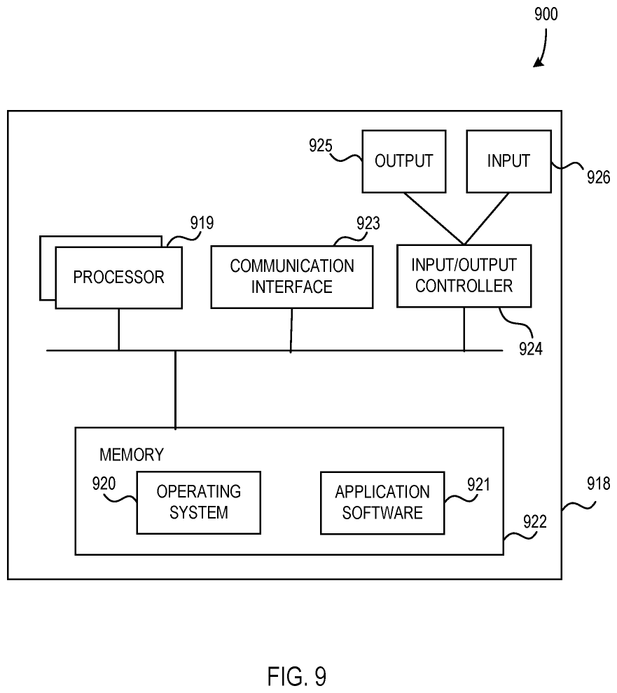

In some examples, the system 100 includes a computing device (e.g., the computing apparatus of FIG. 9). Further, in some examples, the system 100 includes multiple computing devices that are configured to communicate with each other via one or more communication networks (e.g., an intranet, the Internet, a cellular network, other wireless network, other wired network, or the like). In some such examples, entities of the system 100 are configured to be distributed between the multiple computing devices and to communicate with each other via network connections. For instance, in an example, the selection cycle network 102 is located and/or executed on a first computing device or set of computing devices while the item correlation network 104 is located and/or executed on a second computing device or set of computing devices. The selection cycle network 102 and the item correlation network 104 are then configured to communicate with each other via a network connection as described herein. Further, in other examples, the elements of the system 100 are located on and/or executed on a plurality of distributed computing devices in various arrangements and/or organization without departing from the description.

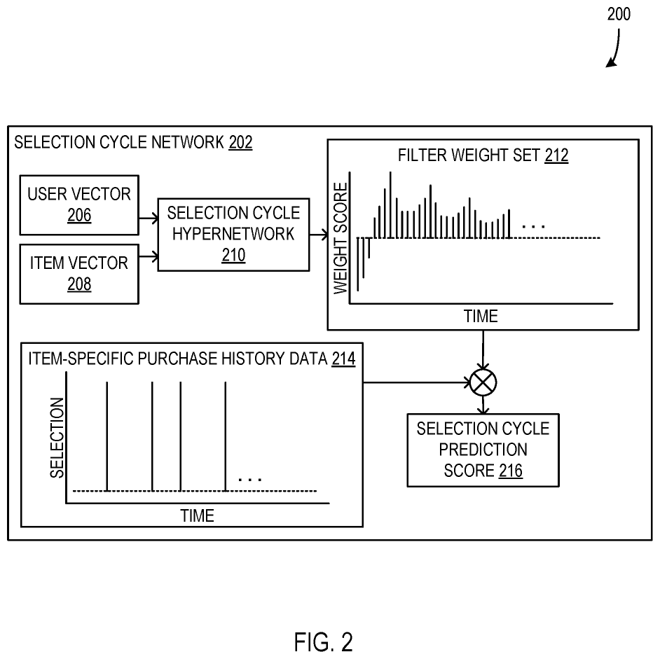

The selection cycle network 102 includes hardware, firmware, and/or software configured to generate selection cycle prediction scores 116 using a selection cycle hypernetwork 110 and item selection history data 114. In some examples, user vectors 106 and item vectors 108 are used by the selection cycle hypernetwork 110 to generate filter weight sets 112 that are applied to the item selection history data 114 to generate the selection cycle prediction scores 116, which are indicative of a likelihood that an item will be selected on a future day from the current time (e.g., the likelihood that a user will select an item in 2 days from today). In some such examples, the user vectors 106 and/or item vectors 108 are learned by the selection cycle network 102 during machine learning processes. Alternatively, or additionally, the vectors 106 and/or 108 are initialized from other vector representations of users and/or items (e.g., a vector representation of an item's metadata based on a belief that items with similar metadata would exhibit a similar selection cycle). The operations of the selection cycle network 102 are described in greater detail below with respect to at least FIG. 2.

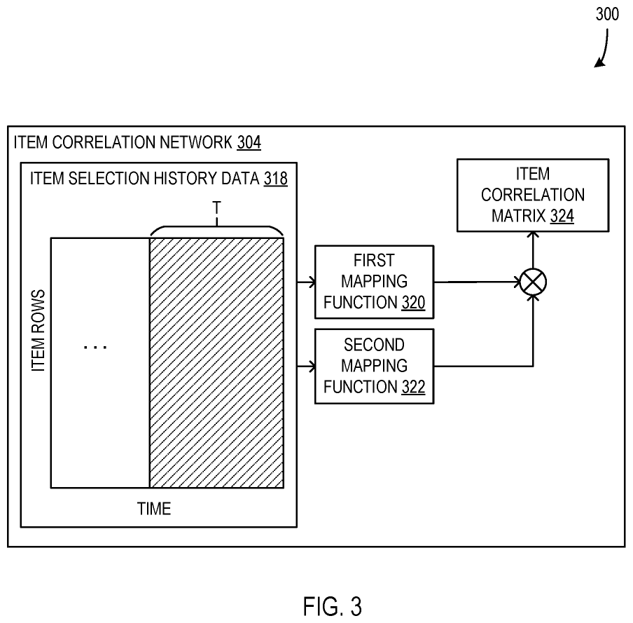

The item correlation network 104 includes hardware, firmware, and/or software configured to generate an item correlation matrix 124 that is indicative of relationships between each item pair of the item selection history data 118. In some examples, item data of the item selection history data 118 is processed using a first mapping function 120 and a second mapping function 122 to generate the item correlation matrix 124 as described herein. Additionally, in some such examples, the item correlation matrix 124 is configured to include item correlation values that are indicative of a likelihood that a pair of items will be selected (e.g., purchased) by the user together (e.g., during the same shopping or item purchasing session). Thus, in such examples, the item correlation matrix 124 includes an item correlation value for each pair of items that are represented in the matrix 124. These item correlation values can be combined to generate combined item correlation values, which can be used in combination with the selection cycle prediction scores 116 to generate the combined prediction scores 126 as described herein. The operations of the item correlation network 104 are described in greater detail below with respect to at least FIG. 3.

Further, in some examples, the selection cycle prediction scores 116 are combined with the item correlation matrix 124 to generate combined prediction scores 126 as described herein. In some examples, the combined prediction scores 126 of multiple items are compared and one or more items are chosen to be recommended to a user profile 130 in a selection recommendation 128. In some such examples, the selection recommendation 128 is displayed to the user profile 130 via a user interface that enables the user profile 130 to then select one or more recommended items. Alternatively, in other examples, the selection recommendation 128 is provided to the user profile 130 in other formats and/or via other interfaces without departing from the description. For instance, in some examples, provided recommendations take the form of recommendations for coupons that anticipate the users' needs and/or reminders for potentially forgotten items.

In some examples, the user profile 130 includes data that identifies a particular user and the user profile 130 is associated with data that is indicative of the user's behavior on a website, on a platform, and/or in other contexts, such as the item selection history data 114 and/or 118. In some such examples, the item selection history data 114 and 118, and other data that is specific to a user is linked to the user profile 130 of that user. Further, in some examples, the user profile 130 includes security information, such as a password or other security measures, that are configured to enable the user with which the user profile 130 is associated to use the user profile 130 and to prevent other users from using the user profile 130. Additionally, or alternatively, in some examples, the user profile 130 is required and/or otherwise used to make item selections (e.g., on a website of a store that enables the user with the user profile 130 to make item selections that are then associate with the user profile 130 in item selection history data 114). The user profile 130 is configured to enable the user to “sign in” to the user profile 130 and then interact with user interface(s) that are associated with the user profile 130 to make item selections, view selection recommendations, view item selection history data 114 and/or related data, or the like. Still further, in some examples where a user-item pair is used to represent a relationship between a specific user and a specific item, the user profile 130 and/or a user identifier associated with the profile 130 is used to represent the user in that relationship, such the user-item pair includes the user profile 130 and an identifier of the specific item in the pair.

In some examples, the system 100 is configured to operate as or otherwise include a hyper-convolutional model for predicting when items will be selected again (e.g., repurchased) which employs a hypernetwork architecture (e.g., the selection cycle hypernetwork 110). The hypernetwork 110 is configured to generate the filter weights as described herein and the second network (e.g., the selection cycle network 102), which is a 1-dimensional convolutional neural network in some examples, makes the ultimate prediction in the form of the selection cycle prediction scores 116. In such examples, the use of hypernetwork architecture provides an efficient alternative to neural attention architecture.

Further, in some examples, the system 100 is configured to account for users' repurchasing behavior, including repetitiveness and loyalty to an item or brand, quasi-stationarity of users' preferences, selection cycles, and item correlations. Repetitiveness and/or loyalty is a notable behavioral pattern with respect to repurchasing items in that users tend to prefer to repeatedly select the same items rather than switch to another brand or an otherwise alternative item. Switching does occur occasionally, but “loyalty” to previously selected items tends to be a much more dominant trend. The strength of such loyalty behavior in predicting reselections can also depend on the types of selections being made (e.g., loyalty is a very strong predictor with respect to online grocery purchases).

Quasi-stationarity of users' preferences includes selection behavioral patterns such as seasonal changes in purchasing of items. Such seasonality or otherwise drifting of the repurchasing behavior can be caused by the item itself (e.g., whether the item is available or not), the user (e.g., a user's dietary changes or need to cut expenses), or some common confounder (e.g., an upcoming holiday or sporting event). For instance, an example of item-related quasi-stationarity is the seasonality of some fresh produce which significantly affects the popularity of the produce at the peak of the season, while availability is significantly reduced when off-season. These behaviors can be observed by looking at selection histories of users using explicit timestamps, which enable seasonality and other similar patterns to be visualized and/or analyzed. In some examples, the system 100 is configured to account for such patterns when detected in the selection histories of users (e.g., changing recommendations for a first type of produce to a second type of produce as the first type of produce goes out of season).

Selection cycles are behavioral patterns that users exhibit as they shop multiple times over a time period. Although users tend to exhibit “loyalty” toward specific products, as discussed above, they do not necessarily select these items in every visit. A user's selection cycle for an item represents the frequency with which they select that item over time. For some items (e.g., bread) a user has a weekly selection cycle, indicating that they tend to purchase the item once a week (and sometimes on the same day each week). For other items, longer or shorter selection cycles are identified and used by the system 100 (e.g., a user has a longer selection cycle for buying paper towels than for bread). Such selection cycles depend on the durability and/or perishability of such products, the quantity in which they are selected, and/or other factors. Further, in some examples, the determined selection cycles are specific to users (e.g., a user that purchases groceries for a family has a shorter selection cycle for many items than a user that purchases groceries for only themselves).

Item correlations are behavior patterns that users exhibit when they tend to select multiple items at the same time (e.g., users tend to select pasta and tomato sauce at the same time). Item correlations may also be called “frequently co-occurring items”. The use of such item-to-item relationships as determined by the item correlation network 104 improve the predictions made by the system 100 as described herein. Such item correlations are determined from selection history data and can arise from sets of items that are all part of a recipe, sets of items that are common at specific events, such as picnics, or the like. Further, some correlations do not stem from a specific need or intent of the user. Instead, some correlations are related to the context of the user's selection session or visit. For example, weekly selection sessions may include large coalitions of correlated items which are not related to a specific need or intent, such that these types of correlations can only be observed at the level of a single user. Additionally, or alternatively, in some examples, some pairs of items even exhibit negative correlations, such that the selection of one item makes it less likely that the other item will also be selected (e.g., similar products from different brands or the like).

In some of the description below, formula notation is used to represent the relationships between various elements of the described systems and processes. In examples where such notation is used, let U={u}ᵤ₌₁^{N}^{_{U}} denote the set of N_{U} users and I={i}ᵢ₌₁^{N}^{_{I}} denote the set of N_{I} items. The associated orders or baskets (e.g., groups or sets of items selected by a user at once or otherwise selected together during a selection session) of a user u are denoted by the set Bᵤ={bᵤ^{r}}ᵣ₌₁^{B}^{ᵤ}, where r denotes the index of the basket, Bᵤ denotes the total number of baskets associated with the user u, and bᵤ^{r} denotes the r^{th} basket, i.e. the set of selected products in the r^{th} selection session and/or visit. An explicit timestamp of a basket is denoted as tᵤ^{r} and the baskets are ordered according to their respective timestamps (e.g., tᵤ¹≤tᵤ²≤ . . . ≤tᵤ^{B}^{ᵤ}). In some examples, the timestamps have a resolution of days, though in other examples, other timestamp resolutions are used without departing from the description. As described herein, the selection cycle network 102 and associated hypernetwork 110 are configured to determine selection cycle patterns at the user-item relationship level, such that selection cycles of a user for each item they select are determined or at least estimated.

Further, let Hᵤ be the set of all items that appear in the selection history of a user u, i.e., Hᵤ:=∪ᵣ₌₁^{B}^{ᵤ}bᵤ^{r}. Given the user's selection history as represented by Bᵤ and the day of the next order or basket selection represented by tᵤ^{B}^{ᵤ}⁺¹, the described system is configured to predict which items in Hᵤ will appear in the user's next basket bᵤ^{B}^{ᵤ}⁺¹.

Additionally, or alternatively, in some examples, a user's selection history (e.g., item selection history data 114 and/or 118) is denoted in at least one of two different ways. The first representation is based on implicit timestamps. This representation is Hᵤ^{im}∈ [symbol] ^{N}^{_{I}}^{×B}^{ᵤ}, where Hᵤ^{im}[i,j]=1 if an item i appeared in the j^{th} basket bᵤ^{j} and zero otherwise. The use of implicit timestamps results in the time periods between consecutive basket selections being ignored by the system, as described herein. The second representation is based on explicit timestamps and is the representation used in most examples of the disclosure. This representation is

$${H}_{u}^{ex} ∈ {ℝ}^{{N}_{I} \times {t}_{u}^{{B}_{u}}} ,$$

where Hᵤ^{ex}[i,tᵤ^{j}]=1 if an item i was selected on the tᵤ^{j}th day (in basket bᵤ^{j}) and zero otherwise. In some examples, in both cases, the datasets represented by H are lists of bits in which each bit is associated with a timestamp (either a basket as an implicit timestamp or a datetime as an explicit timestamp) and the value of each bit indicates whether an item i was selected at that timestamp. It should be understood that the explicit timestamp representation Hᵤ^{ex} is considered sparse because a user may go multiple days without making any selections, resulting in entire columns of the data set being all zeroes.

Other solutions use an ordered sequency of historical selection sessions or visits (e.g., an implicit timestamp representation) but ignore the exact timestamps of the selections. Such solutions ignore the time that passed between two consecutive selection sessions and, as a result, are oblivious to whether a selection session occurred on the previous day or two weeks ago. In contract, the described solution uses the exact timestamps of selection sessions, enabling it to better distinguish selection cycles that cannot be detected otherwise. Many users make repeat selections based on the timing of such selection cycles, resulting in periodic patterns of reselection likelihood (e.g., see the illustrated filter weight set 212 in FIG. 2) that are completely erased when using the implicit timestamp representation of selection history data.

FIG. 2 is a block diagram illustrating a system 200 configured for using a selection cycle network 202 to generate selection cycle prediction scores 216. In some examples, the system 200 is part of or otherwise included in a system such as system 100 of FIG. 1. In the selection cycle network 202, a user vector 206 that is specific to one use and an item vector 208 that is specific to one item are processed by the selection cycle hypernetwork 210 to generate a filter weight set 212, which is illustrated as a graph of a weight score against time. The filter weight set 212 is combined with the item-specific selection history data 214, which is illustrated as a graph of instances when the item was selected against time. The filter weight set 212 and history data 214 are combined using a cross product function or other similar function in some examples. The result is a selection cycle prediction score 216 that is specific to the user and item of the user vector 206 and item vector 208, while also accounting for one or more recent selections of the item by the user.

The illustrated filter weight set 212 displays three phenomena that demonstrate the importance of modeling selection cycles based on explicit timestamps as described herein. First, a periodic pattern emerges that represents users' tendencies to shop at regular intervals, such as weekly intervals, bi-weekly intervals, or the like. Second, the periodic patterns exhibit a time-decay, indicating that prediction of reselections of recently selected items should be prioritized. Third, reselection patterns include portions where the reselection likelihood is negative immediately after the item was selected (e.g., a user is very unlikely to reselect an item in the three days following a previous selection of the same item).

In an example, T denotes a hyperparameter indicating the length of time that is used by the models (e.g., the length of time from which historical data is used by the models). The hypernetwork 210 is configured for a personalized filter weight prediction function that predicts a 1-dimensional filter that matches a personalized selection cycle (e.g., the cycle in which the user of the user vector 206 reselects the item of the item vector 208). In this example, this hypernetwork 210 function is parameterized by θ_{f} and denoted by f^{θ}^{_{f}}: [symbol] ^{d}^{_{U}}× [symbol] ^{d}^{_{I}}→ [symbol] ^{T}. For each pair of vectors (ψᵤ,ϕᵢ)∈ [symbol] ^{d}^{_{U}}× [symbol] ^{d}^{_{I}}, indicating the user (ψᵤ) and the item (ϕᵢ), the hypernetwork 210 outputs a vector of filter weights, or filter taps, w_{u,i}∈ [symbol] ^{T}, which serves as parameters to configure the selection cycle network 202. θ_{f} represents parameters of the hyper network 210 function, ψᵤ and ϕᵢ are learned vectors associated with a user u and an item i respectively (e.g., user vector 108 and item vector 108), and a w_{u,i} is a vector of filter weight values associated with the user-item pair of user u and item i.

Further, in this example, user collaborative filtering (CF) representations are represented by Ψ={ψᵤ}ᵤ₌₁^{N}^{_{U}} and item CF representations are represented by Φ={ϕᵢ}ᵢ₌₁^{N}^{_{I}}, where Ψ⊂ [symbol] ^{d}^{_{U}} and Φ⊂ [symbol] ^{d}^{_{I}}. For a user u and its selection history

$${H}_{u}^{ex} ∈ {ℝ}^{{N}_{1} \times {t}_{u}^{{B}_{u}}}$$

(e.g., item selection history data 214), each item in the catalog is used with the hypernetwork 210 function to generate the corresponding filter weights {w_{u,i}=f^{θ}^{_{f}}(ψᵤ,ϕᵢ)}_{i=1, . . . ,N}_{_{I}}. Then, a 1-dimensional convolution is applied to each row of the selection history data Hᵤ^{ex} and its corresponding filter weights w_{u,i} (e.g., a row of selection history data associated with item A is convolved with a set of filter weights associated item A). The result is denoted by

$${\tilde{S}}_{u} ∈ {ℝ}^{{N}_{1} \times {t}_{u}^{{B}_{u}}} ,$$

where \tilde{S}ᵤ[i, n]=Σₘ₌₁^{T}Hᵤ^{ex}[i,n−m]w_{u,i}[m]. In some examples, the input is padded such that \tilde{S}ᵤ has the same dimensions as Hᵤ^{ex}. An n^{th} column of \tilde{S}ᵤ is denoted as \tilde{s}ᵤⁿ, which represents the prediction scores for the selection of each item from the complete set of items on the n^{th} day. Note that \tilde{s}ₙⁿ[i]>0 only when the item i is present in the user's selection history. It should be understood that, in some such examples, \tilde{S}ᵤ is a 2-dimensional data structure that stores prediction scores associated with a user u for items on specific days or other timestamps, wherein each row is associated with a specific item and each column is associated with a specific day or other timestamps. \tilde{s}ᵤⁿ[i] represents a prediction score for an item i on a specific day n.

FIG. 3 is a block diagram illustrating a system 300 configured for using an item correlation network 304 to generate an item correlation matrix 324. In some examples, the system 300 is part of or otherwise included in a system such as system 100 of FIG. 1. In the item correlation network 304, item selection history data 318 is used with a first mapping function 320 and a second mapping function 322 to generate the item correlation matrix 324. In some examples, as illustrated, the history data 318 is a 2-dimensional data structure with item rows on one axis and time on the other axis. The history data 318 is configured to indicate whether a particular item (e.g., of an item row in the data) was selected at a particular time (e.g., of a time column in the data). In some such examples, the data of the history data 318 used with the mapping functions 320 and 322 includes the data of all item rows over a defined timespan T, which is represented by a plurality of columns in the history data 318. Further, in some examples, data for each pair of items in the history data 318 is run through the first mapping function 320 and the second mapping function 322 and the results combined and included in the item correlation matrix 324, such that a relationship value between each pair of items is recorded in the item correlation matrix 324. The relationship values of the item correlation matrix 324 are indicative of a likelihood that the associated pair of items will be selected together.

In an example, the item correlation network 304 is configured to leverage the pairwise correlations between items bought by the user as described herein. The mapping functions 320 and 322 are denoted by q^{θ}^{_{q}} and k^{θ}^{ₖ}, respectively, where d_{T} is a hyperparameter and θ_{q} and θₖ denote the parameters of q^{θ}^{_{q}} and k^{θ}^{ₖ}, respectively. The parameters of the mapping functions are trained using machine learning techniques as described below in some examples. The item correlation matrix 324 of a user u at day n is denoted by Aᵤⁿ∈ [symbol] ^{N}^{_{I}}^{×N}^{_{I}}, where 1≤n≤tᵤ^{B}^{ᵤ}. The computation of the matrix 324 is done using an attention-like procedure as described herein. For instance, in an example, the functions q^{θ}^{_{q and k}}^{θ}^{ₖ} are applied to each row in the subset of the history data 318 that is the most recent subset of data spanned by the timespan T, or the columns between (n−T−1) and (n−1) of Hᵤ^{ex}. (e.g., the history data 318). The results are denoted by Qᵤⁿ and Kᵤⁿ, where Qᵤⁿ, Kᵤⁿ∈ [symbol] ^{N}^{_{I}}^{×d}^{_{T}}. Then, matrix 324, Aᵤⁿ, is computed by the following multiplication: Aᵤⁿ=QᵤⁿKᵤⁿ^{^{T}}.

Further, in some examples, the matrix 324 is combined with the prediction scores \tilde{S}ᵤ as described above to generate the combined prediction scores 126. In some such examples, the predicted scores for a user u to reselect each item from the catalog on the n^{th} day are given by the multiplication of the n^{th} column of \tilde{S}ᵤ with the personalized item correlation matrix 324: sᵤⁿ=Aᵤⁿ\tilde{s}ᵤⁿ.

In some examples, the parameters of the described models (e.g., the selection cycle hypernetwork 110, the selection cycle network 102, and/or the item correlation network 104) are optimized using machine learning techniques. For instance, in some examples, the mapping functions 320 and 322 (e.g., q^{θ}^{_{q}} and k^{θ}^{ₖ}) are configured as fully connected neural networks with a single Leaky Rectified Linear Unit (Leaky-ReLU) activated hidden layer, such that θ_{q} and θₖ consist of a weight matrix and a bias vector. The hypernetwork 210 function f^{θ}^{_{f}} is implemented via a concatenation of the input vectors followed by a single Leaky-ReLU activated hidden layer, such that θ_{f} consists of a weight matrix and a bias vector. To derive the parameters θ_{q}, θₖ, and θ_{f as} well as the user vectors Ψ and the item vectors Φ, a multi label one-versus-all loss is optimized based on max-entropy between each basket or order in the training set and the model's prediction. An exemplary loss term is:

$${ℒ}_{u}^{r} ( Θ , {b}_{u}^{r} ) = - \frac{1}{\vert {b}_{u}^{r} \vert} {\sum }_{i ∈ \vert {H}_{u} \vert} {H}_{u}^{e x} [ i , {t}_{u}^{r} ] log ( σ ( {s}_{u}^{{t}_{u}^{τ}} [ i ] ) ) + ( 1 - {H}_{u}^{e x} [ i , {t}_{u}^{r} ] ) log ( 1 - σ ( {s}_{u}^{{t}_{u}^{r}} [ i ] ) )$$

$$where σ ( x ) = \frac{1}{1 + exp ( x )} .$$

The average loss term for a user u is given by

$${ℒ}_{u} ( Θ , {B}_{u} ) = \frac{1}{{B}_{u}} {Σ}_{r = 1}^{{B}_{u}} {ℒ}_{u}^{r} ( Θ , {b}_{u}^{r} ) ,$$

and Θ is given by the solution to the following optimization problem: Θ*=arg min Σᵤ₌₁^{N}^{_{U}} [symbol] ᵤ(Θ,Bᵤ). In practice, the optimization proceeds with stochastic gradient descent. Because Hᵤ^{ex} is a sparse matrix, the matrices \tilde{S}ᵤ, Aᵤⁿ, and Qᵤⁿ are sparse matrices as well and consist of |Hᵤ|non-zero rows. Therefore, in practice, w_{u,i} and the 1-dimensional convolutions can be computed only for i∈Hᵤ, facilitating efficient computation with a complexity of O(|Hᵤ|). It should be understood that, in other examples, other types of machine learning techniques are used to train the models and/or optimize parameters thereof without departing from the description.

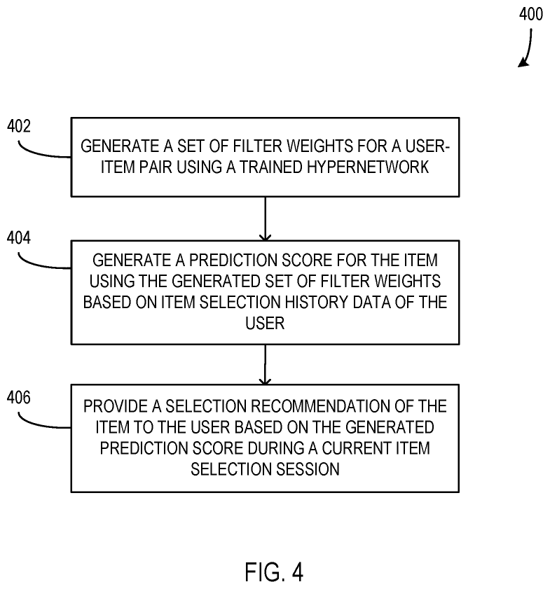

FIG. 4 is a flowchart illustrating a method 400 for generating a prediction score (e.g., prediction score 116) for an item based on a user-specific selection cycle. In some examples, the method 400 is executed or otherwise performed by a system such as system 100 of FIG. 1. Further, in some examples, the method 400 includes interacting with the described user via a user profile (e.g., user profile 130 of FIG. 1) as described herein, such that the user profile 130 is used to make item selections and/or receive or view selection recommendations that are generated for the user.

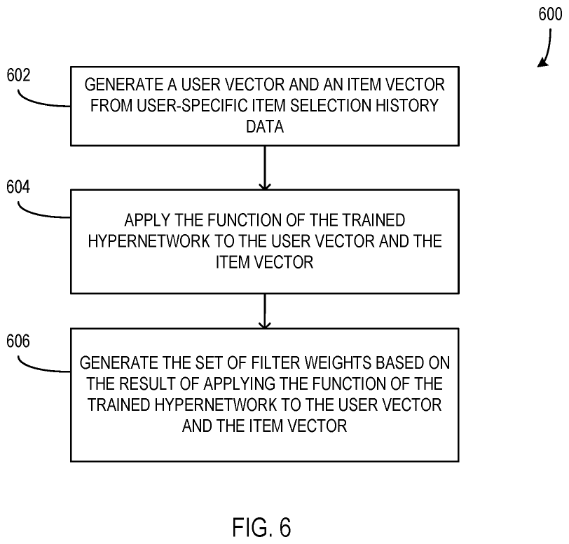

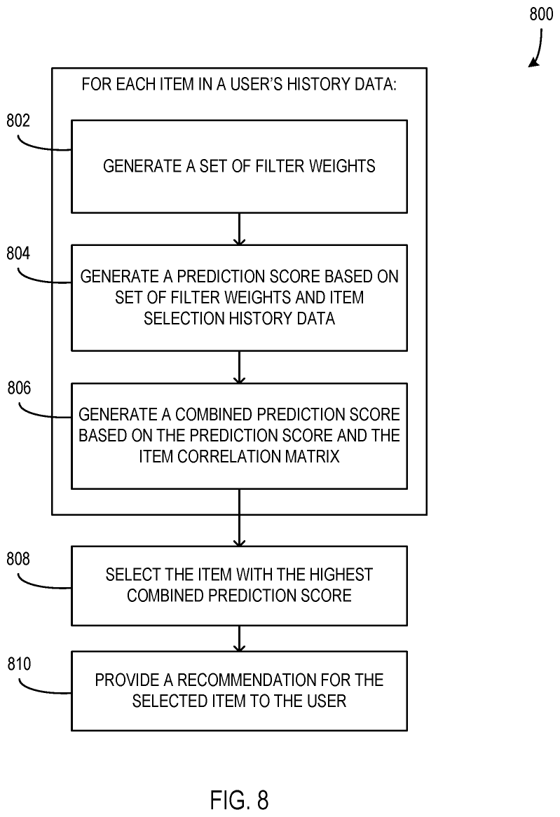

At 402, a set of filter weights is generated for a user-item pair using a trained hypernetwork. In some examples, the generation of the set of filter weights includes generating sets of filter weights for each item that the user of the user-item pair has previously selected (e.g., see FIG. 8 below). Further, in some examples, the optimization of parameters of the trained hypernetwork and/or otherwise the training of the trained hypernetwork is done using machine learning techniques as previously described herein. Additionally, or alternatively, the generation of the set of filter weights further includes applying a function of the hypernetwork to a user vector and an item vector, as described herein (e.g., see FIG. 6 below).

At 404, a prediction score is generated for the item using the generated set of filter weights and based at least in part on item selection history data of the user. In some examples, generating the prediction score includes applying a 1-dimensional convolution between the selection history data of the item and the generated set of filter weights.

At 406, a selection recommendation of the item is provided to the user based on the generated prediction score during a current time period. In some examples, the current time period includes an item selection session (e.g., an online shopping session) in which the user is engaging. In some such examples, the recommendation of the item is displayed to the user via a webpage or other similar interface, providing the user a chance to select the recommended item for selection. In other examples, the recommendation is provided to the user in other forms and/or through other interfaces without departing from the description.

Further, in some examples, the set of filter weights includes filter weight values that are indicative of a probability that the user will select the item in the associated time period. In some examples, the length of the time period is one day, such that each filter weight is associated with a future day-long time period. However, in other examples, other lengths of time periods are used without departing from the description (e.g., a time period of six hours, one week, or the like).

Additionally, or alternatively, in some examples, new item selection history data for a user is received. In some such examples, the set of filter weights for the user-item pair is updated based on the new item selection history data and a new prediction score for the item is generated using the updated set of filter weights and/or the new item selection history data. Then, in some examples, a new selection recommendation for the item is provided to the user based on the new prediction score. Alternatively, in some examples, the new prediction score results in a different item being recommended to the user (e.g., the new prediction score of the time is less than a prediction score of the different item).

It should be understood that, while many examples described herein refer to item selection or purchase in the context of shopping sessions, in other examples, the described systems and methods are used to make predictions and/or recommendations in other contexts. For instance, in an example, the described systems and methods are used to provide travel destination recommendations based on past travel data. Alternatively, in another example, the described systems and methods are used to provide sales contact recommendations or predictions based on past sales contact data.

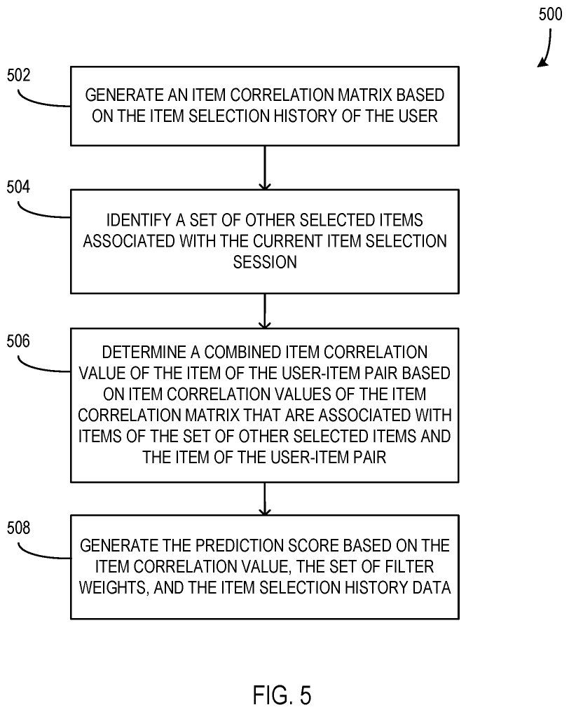

FIG. 5 is a flowchart illustrating a method 500 for generating a prediction score (e.g., a combined prediction score 126) based on a user-specific selection cycle and item correlation data. In some examples, the method 400 is executed or otherwise performed by a system such as system 100 of FIG. 1. Further, in some examples, the method 500 is executed or otherwise performed in combination with method 400 of FIG. 4. Additionally, or alternatively, in some examples, the method 500 includes interacting with the described user via a user profile (e.g., user profile 130 of FIG. 1) as described herein, such that the user profile 130 is used to make item selections and/or receive or view selection recommendations that are generated for the user.

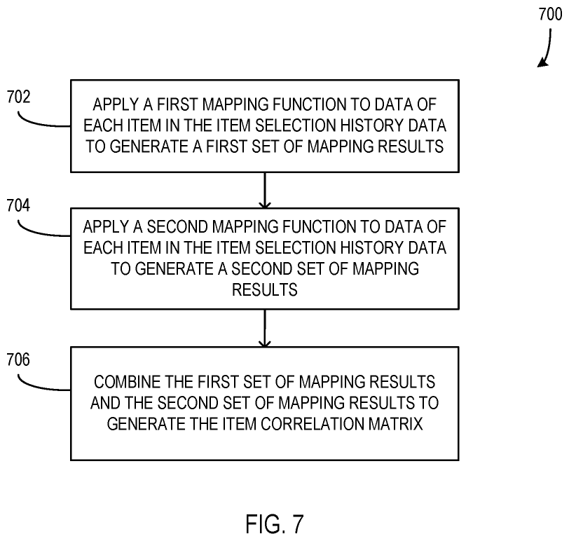

At 502, an item correlation matrix is generated based on the item selection history data of the user. In some examples, the generation of the item correlation matrix is based on the use of two mapping functions as described herein (e.g., see FIG. 7). The item correlation matrix is configured to include correlation data for each possible pair of items in the user's item selection history data, wherein the correlation data is indicative of a likelihood that two items will be selected or otherwise selected during the same time period or session.

At 504, a set of other selected items associated with the current item selection session are identified. In some examples, this includes identifying the items that are already in the user's online shopping cart or basket.

At 506, a combined item correlation value of the item is determined based on item correlation values of the item correlation matrix that are associated with items of the set of other selected items and the item of the user-item pair. In some examples, this includes determining the correlation data values associated with correlations between the item of the user-item pair and each item of the set of other selected items. Those determined correlation data values are combined to arrive at the combined item correlation value.

At 508, the prediction score is generated based on the combined item correlation value and on the set of filter weights and the item selection history data. In some examples, the set of filter weights and the item selection history data are combined to obtain a prediction score as described above with respect to FIG. 4, and then that prediction score is combined with the combined item correlation value to arrive at a final prediction score.

In some examples, that prediction score is then used to provide a selection recommendation of the item as described above with respect to FIG. 4.

FIG. 6 is a flowchart illustrating a method 600 for generating a set of filter weights (e.g., a filter weight set 112) using a trained hypernetwork (e.g., a selection cycle hypernetwork 110). In some examples, the method 600 is executed or otherwise performed in a system such as system 100 of FIG. 1. Further, in some examples, the method 600 is performed as part of or in conjunction with a method such as method 400 of FIG. 4. Additionally, or alternatively, in some examples, the method 600 includes interacting with the described user via a user profile (e.g., user profile 130 of FIG. 1) as described herein, such that the user profile 130 is used to make item selections and/or receive or view selection recommendations that are generated for the user.

At 602, a user vector and an item vector are learned, or otherwise generated, based on user-specific item selection history data (e.g., item selection history data 114). In some examples, the user vector and the item vector are initialized using external machine learning techniques.

At 604, the function of the trained hypernetwork is applied to the user vector and the item vector and, at 606, the set of filter weights is generated as a result of the application of that function. method 700

In some examples, the trained hypernetwork is used to generate a set of filter weights for each item associated with a user, such that, for each user, there are a plurality of sets of filter weights, with one set of filter weights for each item (e.g., see FIG. 8).

FIG. 7 is a flowchart illustrating a method 700 for generating an item correlation matrix (e.g., an item correlation matrix 124). In some examples, the method 700 is executed or otherwise performed in a system such as system 100 of FIG. 1. Further, in some examples, the method 700 is performed as part of or in conjunction with a method such as method 500 of FIG. 5. Additionally, or alternatively, in some examples, the method 700 includes interacting with the described user via a user profile (e.g., user profile 130 of FIG. 1) as described herein, such that the user profile 130 is used to make item selections and/or receive or view selection recommendations that are generated for the user.

At 702, a first mapping function is applied to data of each item in the item selection history data to generate a first set of mapping results and, at 704, a second mapping function is applied to the data of each item in the item selection history data to generate a second set of mapping results.

At 706, the first and second sets of mapping results are combined to generate the item correlation matrix. In some examples, this process is done using an attention-like procedure. Further, in some examples, the first mapping function and the second mapping function are fully connected neural networks with single Leaky Rectified Linear Unit (Leaky-ReLU) activated hidden layers. In some such examples, parameters of the first mapping function and the second mapping function include a weight matrix and a bias vector which are trained during application of the first mapping function and the second mapping function to the data of each item in the item selection history data of the user.

FIG. 8 is a flowchart illustrating a method 800 for providing a recommendation to a user based on combined prediction scores (e.g., combined prediction scores 126) of items in the user's history data. In some examples, the method 800 is executed or otherwise performed in a system such as system 100 of FIG. 1. Additionally, or alternatively, in some examples, the method 500 includes interacting with the described user via a user profile (e.g., user profile 130 of FIG. 1) as described herein, such that the user profile 130 is used to make item selections and/or receive or view selection recommendations that are generated for the user.

The method 800 includes 802-806, which are performed for each item in the user's history data. In this way, a combined prediction score is generated for each item. At 802, a set of filter weights is generated that is indicative of the user's selection cycle for the associated item. In some examples, the generation of the set of filter weights is done using a trained hypernetwork as described herein.

At 804, a prediction score for the item is generated based on the set of filter weights and item selection history data. In some examples, the generation of this prediction score is performed in substantially the same way as described above with respect to at least method 400 of FIG. 4.

At 806, a combined prediction score for the item is generated based on the generated prediction score and the item correlation matrix. In some examples, this combined prediction score is generated in substantially the same way as described above with respect to at least method 500 of FIG. 5.

At 808, the item with the highest combined prediction score is selected and, at 810, a recommendation for the selected item is provided to the user. In some examples, the recommendation is provided to the user in substantially the same way as described above with respect to at least method 400 of FIG. 4. Further, in some examples, more than one item is selected (e.g., the three items with the three highest combined prediction scores) and recommendations for those multiple items are provided to the user, enabling the user to select from among the items and/or select multiple of the recommended items.

### Exemplary Operating Environment

The present disclosure is operable with a computing apparatus according to an embodiment as a functional block diagram 900 in FIG. 9. In an example, components of a computing apparatus 918 are implemented as a part of an electronic device according to one or more embodiments described in this specification. The computing apparatus 918 comprises one or more processors 919 which may be microprocessors, controllers, or any other suitable type of processors for processing computer executable instructions to control the operation of the electronic device. Alternatively, or in addition, the processor 919 is any technology capable of executing logic or instructions, such as a hardcoded machine. In some examples, platform software comprising an operating system 920 or any other suitable platform software is provided on the apparatus 918 to enable application software 921 to be executed on the device. In some examples, generating predictions and/or recommendations of items for users via user profiles based on selection cycle and item correlation networks as described herein is accomplished by software, hardware, and/or firmware.

In some examples, computer executable instructions are provided using any computer-readable media that are accessible by the computing apparatus 918. Computer-readable media include, for example, computer storage media such as a memory 922 and communications media. Computer storage media, such as a memory 922, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 922) is shown within the computing apparatus 918, it will be appreciated by a person skilled in the art, that, in some examples, the storage is distributed or located remotely and accessed via a network or other communication link (e.g., using a communication interface 923).

Further, in some examples, the computing apparatus 918 comprises an input/output controller 924 configured to output information to one or more output devices 925, for example a display or a speaker, which are separate from or integral to the electronic device. Additionally, or alternatively, the input/output controller 924 is configured to receive and process an input from one or more input devices 926, for example, a keyboard, a microphone, or a touchpad. In one example, the output device 925 also acts as the input device. An example of such a device is a touch sensitive display. The input/output controller 924 may also output data to devices other than the output device, e.g., a locally connected printing device. In some examples, a user provides input to the input device(s) 926 and/or receive output from the output device(s) 925.

The functionality described herein can be performed, at least in part, by one or more hardware logic components. According to an embodiment, the computing apparatus 918 is configured by the program code when executed by the processor 919 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises: a processor; and a memory comprising computer program code, the memory and the computer program code configured to, with the processor, cause the processor to: generate a set of filter weights for a user-item pair using a trained hypernetwork, wherein the set of filter weights includes filter weights associated with each time period of a set of time periods after an item of the user-item pair was last selected by a user profile of the user-item pair, and wherein each filter weight is indicative of a probability that the user profile will select the item at the associated time period; generate a prediction score for the item using the generated set of filter weights based at least in part on item selection history data of the user profile and a timestamp at which the user profile last selected the item; and provide a selection recommendation of the item to a user interface associated with the user profile based at least in part on the generated prediction score during a current time period.

An example computerized method comprises: generating a set of filter weights for a user-item pair using a trained hypernetwork, wherein the set of filter weights includes filter weights associated with each time period of a set of time periods after an item of the user-item pair was last selected by a user profile of the user-item pair, and wherein each filter weight is indicative of a probability that the user profile will select the item at the associated time period; generating a prediction score for the item using the generated set of filter weights based at least in part on item selection history data of the user profile and a timestamp at which the user profile last selected the item; and providing a selection recommendation of the item to the user profile based at least in part on the generated prediction score during a current time period.

One or more computer storage media having computer-executable instructions that, upon execution by a processor, cause the processor to at least: generate a set of filter weights for a user-item pair using a trained hypernetwork, wherein the set of filter weights includes filter weights associated with each time period of a set of time periods after an item of the user-item pair was last selected by a user profile of the user-item pair, and wherein each filter weight is indicative of a probability that the user profile will select the item at the associated time period; generate a prediction score for the item using the generated set of filter weights based at least in part on item selection history data of the user profile and a timestamp at which the user profile last selected the item; and provide a selection recommendation of the item to the user profile based at least in part on the generated prediction score during a current time period.

Alternatively, or in addition to the other examples described herein, examples include any combination of the following:
wherein generating the set of filter weights for the user-item pair using the trained hypernetwork includes: generating a user vector of the user profile of the user-item pair and an item vector of the item of the user-item pair; applying a function of the trained hypernetwork to the user vector and the item vector; and generating the set of filter weights for the user-item pair based at least in part on a result of applying the function of the trained hypernetwork to the user vector and the item vector.
further comprising: generating an item correlation matrix based at least in part on the item selection history data of the user profile, wherein the item correlation matrix includes item correlation values indicative of a likelihood that two items will both be selected by the user profile during an item selection session; identifying a set of other selected items associated with the current item selection session; and determining a combined item correlation value of the item of the user-item pair based at least in part on item correlation values of the item correlation matrix that are associated with items of the set of other selected items and the item of the user-item pair; wherein generating the prediction score for the item is further based at least in part on the determined combined item correlation value of the item.
wherein generating the item correlation matrix includes: applying a first mapping function to data of each item in the item selection history data of the user profile to generate a first set of mapping results; applying a second mapping function to data of each item in the item selection history data of the user profile to generate a second set of mapping results; and combining the first set of mapping results and the second set of mapping results to generate the item correlation matrix.
wherein the first mapping function and the second mapping function are fully connected neural networks with single Leaky Rectified Linear Unit (Leaky-ReLU) activated hidden layers; and wherein parameters of the first mapping function and the second mapping function include a weight matrix and a bias vector which are trained during application of the first mapping function and the second mapping function to the data of each item in the item selection history data of the user profile.
further comprising: generating a plurality of sets of filter weights for a user profile using the trained hypernetwork, wherein each set of the plurality of sets of filter weights is associated with an item of a set of items that the user profile has previously selected; and generating a plurality of prediction scores for the set of items that the user profile has previously selected using the generated plurality of sets of filter weights based at least in part on an item selection history data of the user profile and time periods at which the user profile last selected each item of the set of items that the user profile has previously selected; wherein providing the selection recommendation for the item is further based at least in part on comparing the generated plurality of prediction scores and determining that the prediction score associated with the item is the highest prediction score of the plurality of prediction scores.
further comprising: receiving new item selection history data of the user profile; updating the set of filter weights for the user-item pair using a trained hypernetwork based at least in part on the received new item selection history data; generating a new prediction score for the item using the updated set of filter weights based at least in part on the received new item selection history data of the user profile and a timestamp at which the user profile last selected the item; and providing a new selection recommendation of the item to the user interface associated with the user profile based at least in part on the generated new prediction score during a current time period.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for generating a set of filter weights for a user-item pair using a trained hypernetwork, wherein the set of filter weights includes filter weights associated with each time period of a set of time periods after an item of the user-item pair was last selected by a user profile of the user-item pair, and wherein each filter weight is indicative of a probability that the user profile will select the item at the associated time period; exemplary means for generating a prediction score for the item using the generated set of filter weights based at least in part on item selection history data of the user profile and a timestamp at which the user profile last selected the item; and exemplary means for providing a selection recommendation of the item to a user interface associated with the user profile based at least in part on the generated prediction score during a current time period.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of ” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a memory comprising computer program code, the memory and the computer program code configured to, with the processor, cause the processor to:
generate a set of filter weights for a user-item pair using a trained hypernetwork, wherein the set of filter weights includes filter weights associated with each time period of a set of time periods after an item of the user-item pair was last selected by a user profile of the user-item pair, and wherein each filter weight is indicative of a probability that the user profile will select the item at the associated time period;
generate a prediction score for the item using the generated set of filter weights based at least in part on item selection history data of the user profile and a timestamp at which the user profile last selected the item; and
provide a selection recommendation of the item to a user interface associated with the user profile based at least in part on the generated prediction score during a current time period.

2. The system of claim 1, wherein generating the set of filter weights for the user-item pair using the trained hypernetwork includes:
generating a user vector of the user profile of the user-item pair and an item vector of the item of the user-item pair;
applying a function of the trained hypernetwork to the user vector and the item vector; and
generating the set of filter weights for the user-item pair based at least in part on a result of applying the function of the trained hypernetwork to the user vector and the item vector.

3. The system of claim 1, wherein the at least one memory and the computer program code are configured to, with the at least one processor, further cause the at least one processor to:
generate an item correlation matrix based at least in part on the item selection history data of the user profile, wherein the item correlation matrix includes item correlation values indicative of a likelihood that two items will both be selected by the user profile during an item selection session;
identify a set of other selected items associated with a current item selection session; and
determine a combined item correlation value of the item of the user-item pair based at least in part on item correlation values of the item correlation matrix that are associated with items of the set of other selected items and the item of the user-item pair;
wherein generating the prediction score for the item is further based at least in part on the determined combined item correlation value of the item.

4. The system of claim 3, wherein generating the item correlation matrix includes:
Applying a first mapping function to data of each item in the item selection history data of the user profile to generate a first set of mapping results;
applying a second mapping function to data of each item in the item selection history data of the user profile to generate a second set of mapping results; and
combining the first set of mapping results and the second set of mapping results to generate the item correlation matrix.

5. The system of claim 4, wherein the first mapping function and the second mapping function are fully connected neural networks with single Leaky Rectified Linear Unit (Leaky-ReLU) activated hidden layers; and
Wherein parameters of the first mapping function and the second mapping function include a weight matrix and a bias vector which are trained during application of the first mapping function and the second mapping function to the data of each item in the item selection history data of the user profile.

6. The system of claim 1, wherein the at least one memory and the computer program code are configured to, with the at least one processor, further cause the at least one processor to:
generate a plurality of sets of filter weights for a user profile using the trained hypemetwork, wherein each set of the plurality of sets of filter weights is associated with an item of a set of items that the user profile has previously selected; and
generate a plurality of prediction scores for the set of items that the user profile has previously selected using the generated plurality of sets of filter weights based at least in part on an item selection history data of the user profile and time periods at which the user profile last selected each item of the set of items that the user profile has previously selected;
wherein providing the selection recommendation for the item is further based at least in part on comparing the generated plurality of prediction scores and determining that the prediction score associated with the item is the highest prediction score of the plurality of prediction scores.

7. The system of claim 1, wherein the at least one memory and the computer program code are configured to, with the at least one processor, further cause the at least one processor to:
receive new item selection history data of the user profile;
update the set of filter weights for the user-item pair using a trained hypemetwork based at least in part on the received new item selection history data;
generate a new prediction score for the item using the updated set of filter weights based at least in part on the received new item selection history data of the user profile and a timestamp at which the user profile last selected the item; and
provide a new selection recommendation of the item to the user interface associated with the user profile based at least in part on the generated new prediction score during a current time period.

8. A computerized method comprising:
generating a set of filter weights for a user-item pair using a trained hypemetwork, wherein the set of filter weights includes filter weights associated with each time period of a set of time periods after an item of the user-item pair was last selected by a user profile of the user-item pair, and wherein each filter weight is indicative of a probability that the user profile will select the item at the associated time period;
generating a prediction score for the item using the generated set of filter weights based at least in part on item selection history data of the user profile and a timestamp at which the user profile last selected the item; and
providing a selection recommendation of the item to the user profile based at least in part on the generated prediction score during a current time period.

9. The computerized method of claim 8, wherein generating the set of filter weights for the user-item pair using the trained hypernetwork includes:
generating a user vector of the user profile of the user-item pair and an item vector of the item of the user-item pair;
applying a function of the trained hypernetwork to the user vector and the item vector; and
generating the set of filter weights for the user-item pair based at least in part on a result of applying the function of the trained hypernetwork to the user vector and the item vector.

10. The computerized method of claim 8, further comprising:
generating an item correlation matrix based at least in part on the item selection history data of the user profile, wherein the item correlation matrix includes item correlation values indicative of a likelihood that two items will both be selected by the user profile during an item selection session;
identifying a set of other selected items associated with a current item selection session; and
determining a combined item correlation value of the item of the user-item pair based at least in part on item correlation values of the item correlation matrix that are associated with items of the set of other selected items and the item of the user-item pair;
wherein generating the prediction score for the item is further based at least in part on the determined combined item correlation value of the item.

11. The computerized method of claim 10, wherein generating the item correlation matrix includes:
applying a first mapping function to data of each item in the item selection history data of the user profile to generate a first set of mapping results;
applying a second mapping function to data of each item in the item selection history data of the user profile to generate a second set of mapping results; and
combining the first set of mapping results and the second set of mapping results to generate the item correlation matrix.

12. The computerized method of claim 11, wherein the first mapping function and the second mapping function are fully connected neural networks with single Leaky Rectified Linear Unit (Leaky-ReLU) activated hidden layers; and
wherein parameters of the first mapping function and the second mapping function include a weight matrix and a bias vector which are trained during application of the first mapping function and the second mapping function to the data of each item in the item selection history data of the user profile.

13. The computerized method of claim 8, further comprising:
generating a plurality of sets of filter weights for a user profile using the trained hypernetwork, wherein each set of the plurality of sets of filter weights is associated with an item of a set of items that the user profile has previously selected; and
generating a plurality of prediction scores for the set of items that the user profile has previously selected using the generated plurality of sets of filter weights based at least in part on an item selection history data of the user profile and time periods at which the user profile last selected each item of the set of items that the user profile has previously selected;
wherein providing the selection recommendation for the item is further based at least in part on comparing the generated plurality of prediction scores and determining that the prediction score associated with the item is the highest prediction score of the plurality of prediction scores.

14. The computerized method of claim 8, further comprising:
receiving new item selection history data of the user profile;
updating the set of filter weights for the user-item pair using a trained hypernetwork based at least in part on the received new item selection history data;
generating a new prediction score for the item using the updated set of filter weights based at least in part on the received new item selection history data of the user profile and a timestamp at which the user profile last selected the item; and
providing a new selection recommendation of the item to the user interface associated with the user profile based at least in part on the generated new prediction score during a current time period.

15. One or more computer storage media having computer-executable instructions that, upon execution by a processor, cause the processor to at least:
generate a set of filter weights for a user-item pair using a trained hypernetwork, wherein the set of filter weights includes filter weights associated with each time period of a set of time periods after an item of the user-item pair was last selected by a user profile of the user-item pair, and wherein each filter weight is indicative of a probability that the user profile will select the item at the associated time period;
generate a prediction score for the item using the generated set of filter weights based at least in part on item selection history data of the user profile and a timestamp at which the user profile last selected the item; and
provide a selection recommendation of the item to the user profile based at least in part on the generated prediction score during a current time period.

16. The one or more computer storage media of claim 15, wherein generating the set of filter weights for the user-item pair using the trained hypernetwork includes:
generating a user vector of the user profile of the user-item pair and an item vector of the item of the user-item pair;
applying a function of the trained hypernetwork to the user vector and the item vector; and
generating the set of filter weights for the user-item pair based at least in part on a result of applying the function of the trained hypernetwork to the user vector and the item vector.

17. The one or more computer storage media of claim 15, wherein the computer-executable instructions, upon execution by a processor, further cause the processor to at least:
generate an item correlation matrix based at least in part on the item selection history data of the user profile, wherein the item correlation matrix includes item correlation values indicative of a likelihood that two items will both be selected by the user profile during an item selection session;
identify a set of other selected items associated with a current item selection session; and
determine a combined item correlation value of the item of the user-item pair based at least in part on item correlation values of the item correlation matrix that are associated with items of the set of other selected items and the item of the user-item pair;
wherein generating the prediction score for the item is further based at least in part on the determined combined item correlation value of the item.

18. The one or more computer storage media of claim 17, wherein generating the item correlation matrix includes:
applying a first mapping function to data of each item in the item selection history data of the user profile to generate a first set of mapping results;
applying a second mapping function to data of each item in the item selection history data of the user profile to generate a second set of mapping results; and
combining the first set of mapping results and the second set of mapping results to generate the item correlation matrix.

19. The one or more computer storage media of claim 18, wherein the first mapping function and the second mapping function are fully connected neural networks with single Leaky Rectified Linear Unit (Leaky-ReLU) activated hidden layers; and
wherein parameters of the first mapping function and the second mapping function include a weight matrix and a bias vector which are trained during application of the first mapping function and the second mapping function to the data of each item in the item selection history data of the user profile.

20. The one or more computer storage media of claim 15, wherein the computer-executable instructions, upon execution by a processor, further cause the processor to at least:
generate a plurality of sets of filter weights for a user profile using the trained hypernetwork, wherein each set of the plurality of sets of filter weights is associated with an item of a set of items that the user profile has previously selected; and
generate a plurality of prediction scores for the set of items that the user profile has previously selected using the generated plurality of sets of filter weights based at least in part on an item selection history data of the user profile and time periods at which the user profile last selected each item of the set of items that the user profile has previously selected;
wherein providing the selection recommendation for the item is further based at least in part on comparing the generated plurality of prediction scores and determining that the prediction score associated with the item is the highest prediction score of the plurality of prediction scores.
